(19) United States
(12) Patent Application Publication
(10) Pub. No.: US 2021/0219526 A1
(43) Pub. Date: Jul. 22, 2021

(54) Cummings No-leak Entrance Feeder for Honey Bees

(71) Applicant: Joe M. Cummings, Aaron, KY (US)

(72) Inventor: Joe M. Cummings, Aaron, KY (US)

(21) Appl. No.: 16/663,707

(22) Filed: Jan. 22, 2020

(51) Int. Cl. A01K 53/00; A01K 47/06

(52) U.S. Cl. CPC A01K 53/00; A01K 47/06

(57) ABSTRACT

The Cummings No-Leak Entrance Feeder for Honey Bees is designed with a double lock against leakage. The first safeguard is the traditional suction vapor lock. If that fails, the sugar syrup food will pool in the feeder and stop when it rises to the level of the canning jar lid. The bees will be able to continue to feed from the pool instead of directly from the jar lid. This will prevent the loss of food which would in turn encourage robber bees to attack the hive.

### BACKGROUND OF INVENTION

I keep honey bees and have for years used a common canning jar entrance feeder that uses a suction vapor lock to prevent the sugar syrup feed from leaking.

### SUMMARY OF INVENTION

The standard canning jar entrance feeder is prone to leak. That wastes the food and causes problems with keeping the bees. My invention provides a second pooling lock to prevent leakage in the event the original suction vapor lock fails. The entrance feeder is made in two parts of plastic and still accepts a common canning jar to contain the food.

### ATTACHED PAGE WITH DRAWINGS OF INVENTION-REPLACEMENT DRAWINGS

FIG. 1: This is an assembly drawing of the “Entrance Feeder”. It is two parts (FIGS. 2 and 3) that snap together and come apart for cleaning. The “Entrance Feeder” is made from plastic and is about 8 inches by 3 inches by ¾ inch.

FIG. 2: This a a view of the bottom of the “Entrance Feeder”.

FIG. 3: This a a view of the top of the “Entrance Feeder”.

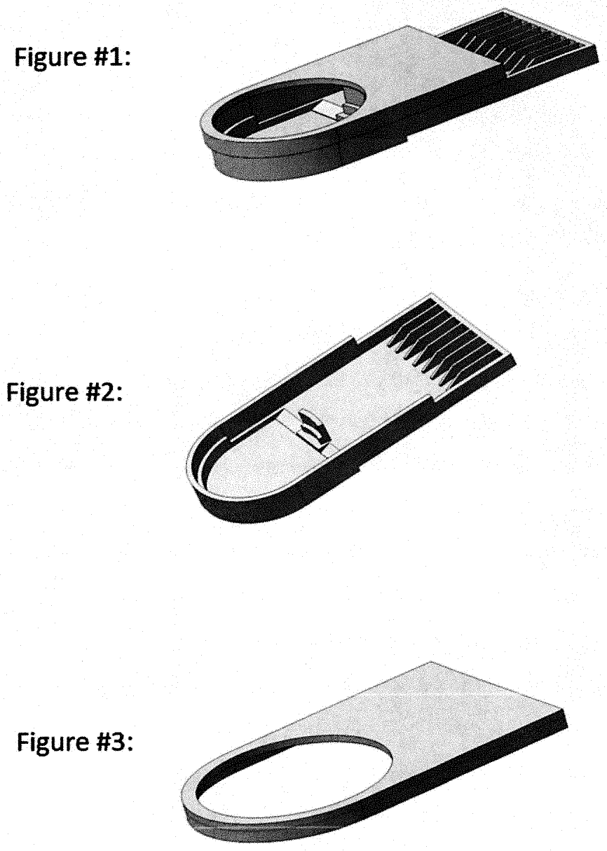

I claim:

1: This invention reduces the chance of the sugar syrup food leaking from the Cummings No-Leak Entrance Feeder for Honey Bees and loss of food.

2: This invention reduces the chance of the sugar syrup food leaking from the Cummings No-Leak Entrance Feeder for Honey Bees and thereby increasing the chance of encouraging robber bees.
